(19) United States
(12) Patent Application Publication
(10) Pub. No.: US 2005/0038738 A1
(43) Pub. Date: Feb. 17, 2005

(54) System for a account authorisation

(76) Inventors: Matthew Peck, Slough (GB); Michael Alculumbre, London (GB)

Correspondence Address: OSTROLENK FABER GERB & SOFFEN, 1180 AVENUE OF THE AMERICAS, NEW YORK, NY, 100368403, US

(21) Appl. No.: 10/503,164

(22) PCT Filed: Feb. 4, 2003
(86) PCT No.: PCT/GB03/00482

(30) Foreign Application Priority Data
Feb. 4, 2002 (GB) 0202542.7

(51) Int. Cl. G06F 17/60

(52) U.S. Cl. 705/40

(57) ABSTRACT

To maintain the authorisation on a credit card payment in order to delay completion of the transaction until goods are delivered to a customer, the payment authorisation is periodically reversed and then re-applied.

The present invention relates to a system for account authorisation. The system relates particularly to maintaining an authorisation on a financial account, but may have application in other areas as well. The system is particularly useful with card based payment systems, such as credit cards.

Payment card schemes in which a cardholder (the customer) makes a purchase of goods or services from a merchant (a vendor or seller) have been well known for many years. Such payment card schemes operate in a variety of ways.

A credit card is an instalment based repayment system. The cardholder has an account with the card issuer who may be a bank, a store, or some other organisation. A merchant intending to accept payment with the card must seek an authorisation from the card issuer (vide hereinafter). Primarily this provides an immediate check on whether a lost or stolen card is being used fraudulently (in which case the original cardholder may have notified the issuer who ‘hot lists’ the card), and whether the cardholder has sufficient credit available to make the transaction. The card typically has an account limit which is set by the card issuer, and the cardholder pays interest on the unpaid balance of the account. Use of the card to make a payment results in a debit on the account.

A chargecard works in a similar way in that any purchases are accumulated as debits on the account. The principal difference is that the cardholder must clear the account at the end of the accounting period-typically every month. American Express and Diners are well known chargecard systems. Often there is no apparent spending limit on such accounts, but it is necessary for merchants to seek authorisation to confirm that a payment made with the card will be accepted by the card issuer.

Debit cards, such as Switch and Delta, are linked direct to the cardholder's “normal” bank account or savings account. A payment made with the card is deducted almost immediately from the account, but again an authorisation process is required.

A merchant, who wishes to accept payment by payment card must be registered with an acquirer who oversees the necessary banking transactions involved with transfer of funds from the card issuer to the merchant. The acquirer obtains the funds from the issuer, and then transfers them to the merchant. The issuer seeks payment from the cardholder. In card transactions the merchant is at risk in the sense that he will not receive payment or must make a refund to the issuer (a chargeback) if the transaction is repudiated for some reason, for example if the card is lost or stolen, a credit limit exceeded, or the user denies the authenticity of the transaction.

Historically, use of payment cards was a manual transaction in which the cardholder was present at the point of sale in order to sign a voucher which the merchant prepared by copying information from the card. Periodically the slips were forwarded to the acquirer dealing with the respective card issuer. Electronic point of sale terminals were developed. A card is swiped at the merchant's premises, automatically generating a payment slip for signature by the cardholder, and storing the card information and transaction amount for automatic transmission to the acquirer.

Merchants may also take card details by mail or over the telephone, i.e. with the cardholder not present. Potentially this has always provided an increased risk for both parties. There is greater opportunity for the cardholder to repudiate the transaction (deny that authorisation was given). In that circumstance a “chargeback” results, the merchant will not receive or must refund the payment and must pursue the cardholder if the repudiation is unwarranted. Conversely, if the cardholder has ordered goods by mail or over the telephone and given a verifiable authorisation, and the goods do not arrive or are unsuitable, the financial transaction itself may have been properly completed-the payment being debited from the cardholder account and transferred to the merchant. The cardholder must then pursue the merchant.

With the rapid expansion of the internet, and the use of the world wide web by both cardholders and merchants, the payment card system provides a very simple way for the cardholders to pay for goods and services. The drawback which has been recognised for quite some time is the increased risk of fraud with such internet based transactions. This arises, for example, from the ability of individuals and organisations to set up bogus transactions, creating a high volume in a short time period, as well as eavesdropping or hacking by third parties. A number of systems have been proposed and put in place in an effort to reduce the risk of fraud. Those range from “trusted third party” systems to system protocols such as SET (secure electronic transactions) developed by the leading card associates VISA and MASTERCARD. These systems rely on various degrees of data encryption, but also put new methodologies in place.

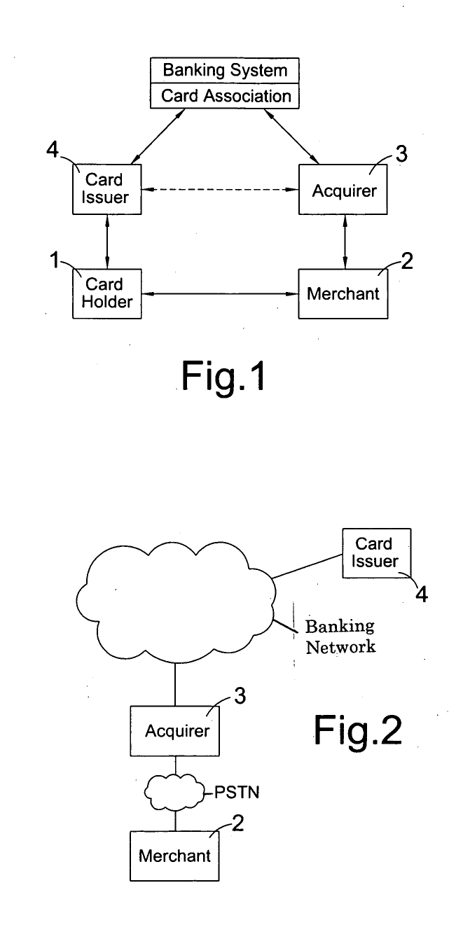

A typical payment card transaction is set out in FIG. 1. The cardholder 1 establishes a dialogue with a merchant 2 and agrees to purchase goods or services from the merchant, using the payment card. The cardholder passes card details to the merchant. The merchant then passes the card details and details of the transaction, primarily the amount of the payment required, to the acquirer 3. The acquirer in turn communicates with the card issuer 4, typically via the banking system or card association 5 such as VISA or MASTERCARD, in order to confirm that the cardholder's account details are valid and that the appropriate payment can be made from the account. The card issuer 4 provides a confirmation or authorisation back to the acquirer, who in turn provides an authorisation to the merchant 2. When the merchant receives the authorisation he knows that the financial transaction can be completed and so can release the goods or services. There is, of course, still the option for the cardholder to repudiate the transaction at a later date, alleging fraud. For transactions where the cardholder is remote from the merchant, the cardholder may be required to provide additional details such as a card expiry date, address or other personal information not readily available to a third party-to reduce the risk of fraud.

Because of the volume of transactions being made, the card issuer or card association may agree an upper limit, below which a merchant does not need to obtain prior authorisation.

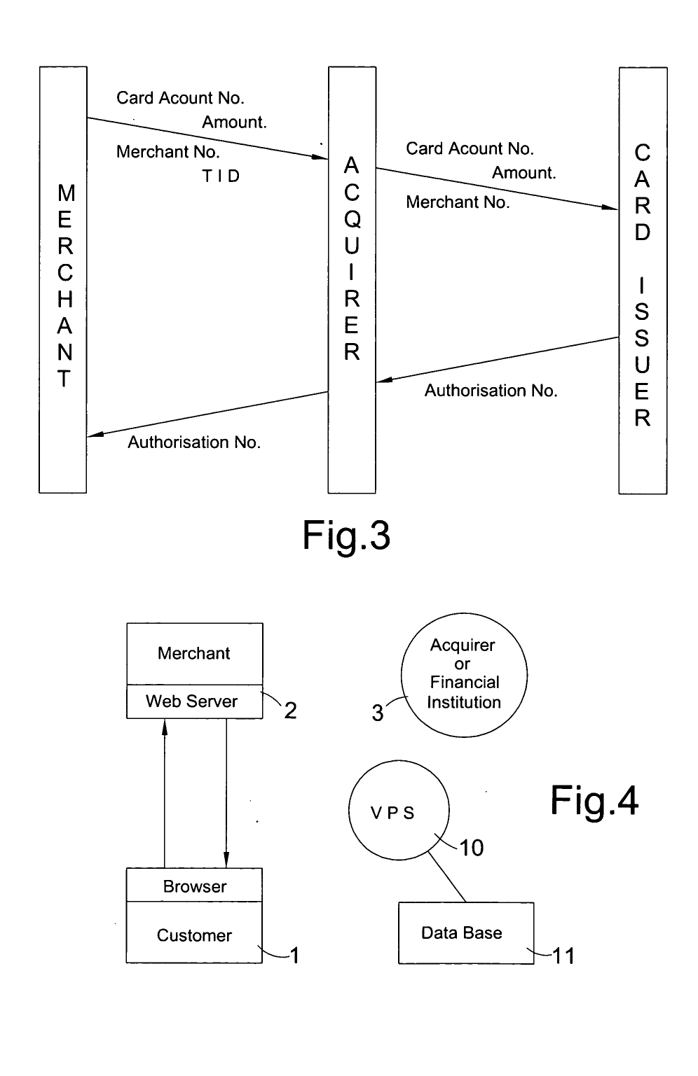

Referring to FIGS. 2 and 3 when a merchant 2 seeks authorisation from an acquirer 3, he passes sufficient information to identify the cardholder's account, for example the card number or the card number and expiry date and optionally address details, to the acquirer 3, together with the value of the transaction and optionally a time code for the transaction (YYMMDDhhmm). The merchant 2 will also transmit his merchant identifier (an ID number which is established between the merchant and the acquirer when the merchant is registered with the acquirer) together with a terminal ID number (TID). A merchant can have several TIDs to allow the merchant to process several transactions in parallel with the acquirer, for example from multiple terminals at the merchant's establishment. The acquirer transmits back to the merchant the appropriate authorisation number after a check has been made with the card issuer etc. The merchant will typically communicate with the acquirer over a private telephone line (PSTN) or network, and the acquirer will communicate with the card issuer over the banking network. The actual communication protocol, message format, etc. is specified by the card authorities such as the Association for Payment Clearing Services (APACS) and the protocols and formats may be readily obtained from them by bona fide parties.

The very large number of transactions taking place each day across the world does not readily permit the banking system to provide real time operation of the accounts, that is the transfer of money by debiting the cardholders account and crediting the merchants account the moment a payment is agreed between the cardholder and the merchant and authorised by the card issuer.

As mentioned above, typically, a merchant will seek authorisation (in effect clearance) for a card payment at the time of sale, and receive an authorisation code from the acquirer. The transactions made by a merchant during the day are stored by the merchant (done automatically on the merchants electronic terminal) and the accumulated transactions are then transmitted overnight as a batch to the acquirer, and then they are processed through the banking system. Thus, there is a delay between an authorisation being given-showing that sufficient funds may be deducted from the cardholders payment card account-and the deduction actually appearing on the account at the card issuer. When a merchant seeks an authorisation from the acquirer, the card issuer (contacted by the acquirer) places a shadow on the cardholders account. Thus if the authorisation is for a payment of £1,000, say, then the card issuer effectively reduces the available credit limit of the cardholder by £1,000. This ensures that if subsequent purchases are made by the cardholder before the authorised merchant transaction has been fully processed through the banking system, the required credit of £1,000 will still be available on the cardholders account.

With debit card systems, the merchant is expected to process the transaction fully with the acquirer at the end of the day the payment is agreed by the cardholder, and so the authorisations given for chargecard systems, and hence the related shadowing period, may last only 24 hours. Other systems such as credit cards may provide an authorisation period of 7 or 14 days, for example.

In some situations, a merchant may wish to seek authorisation on an account several days before actually processing the account payment. A typical example would be in a hotel, where the guest is asked to provide card details but not actually invoiced until the end of the stay, or where a merchant has agreed to take payment in instalments.

If the merchant attempts to process a transaction after the authorisation period has expired, then the transaction may be repudiated by the card issuer (for example because the credit limit of the cardholder has been exceeded or the card has been reported lost). It follows that it is in the merchant's interest to complete a transaction through the acquirer as soon as possible.

With mail order and telephone order systems, and even more so with Internet payment systems, many purchasers have encountered difficulties because the goods or services are unsuitable in some way, or have simply not been provided. It follows that the cardholder and merchant may want to agree that the financial transaction will not actually be completed until the goods or services have been received by the cardholder. The difficulty for the merchant is that the payment card authorisation system does not necessarily provide a sufficient period of time for the physical transaction, the receipt of the goods by the cardholder, to be completed before the authorisation on the card expires.

One way in which these problems have been addressed is for a third party to establish an escrow account. In this system, the cardholder and merchant deal with the third party who holds the money in escrow once the transaction has been agreed, and transfers the money to the merchant after the cardholder has accepted that the goods or services are adequate. In this situation, the third party, the escrow account holder, will typically sit between the merchant and the acquirer, effectively dealing with the acquirer as though it is a merchant, so that the payment is made by the cardholder to the escrow party, who in turn will transfer the payment to the merchant. Inevitably, the escrow party will charge a commission to one or both of the cardholder and merchant, and may be obliged to resolve disputes and be obliged to enter into a contract with the parties.

As mentioned above, a number of specialised payment systems involving a third party have been developed for payment on the World Wide Web, i.e. using the Internet, in order to allow a transaction to be made without the cardholder providing his card details to the merchant, or at least without providing them “in clear” to the merchant. These payment systems involve a trusted third party (TTP).

One early system was the FIRST VIRTUAL system. With the FIRST VIRTUAL system, merchants and cardholders register with the TTP (First Virtual). The cardholder will register his card details and e-mail address and receive an account number and a secret code such as a phrase and a personal identification (PIN) to use with the system. The card details can be passed to the TTP over the internet in encrypted form or by telephone or facsimile.

The merchant will also register with the TTP. In a typical session the buyer downloads, i.e. browses, the pages on the merchant's web server. When transaction details (goods/services and price) have been agreed, the buyer provides his TTP account details to the merchant. The merchant accesses the TTP system to electronically confirm the account ID is valid and in turn provide transaction details to the TTP and the requested goods etc to the buyer. The TTP subsequently checks, by e-mail, that the buyer is satisfied with the goods and will then complete the payment process if a positive indication is received from the buyer.

The buyer's payment card account is debited (by the TTP system) and the payment credited to the merchant. Thus, the TTP takes the place of the merchant in dealing with the acquirer. This system can have the benefit that the buyer need not provide payment card details to the merchant, but the buyer does nevertheless provide an account ID to the merchant. Although even the ID may be encrypted at the buyer's terminal, the repeated transmission of encrypted information from a single source or from a number of sources may enable unauthorised decryption.

Referring to FIG. 4, a verified payment system (VPS) using a trusted third party (TTP) of the type described in WO99/66436 will be set out.

In the preferred system both the cardholder (customer) 1 and merchant (vendor) 2 are pre-registered with the VPS 10. The cardholder provides card details to the VPS. The cardholder may register details for a number of cards with the VPS, in order to be able to be able to select a card when a transaction is to take place. The merchant also registers with the VPS, providing to the VPS the merchant ID and details of acquirers used by that merchant for payment card transactions. This information (data) is stored by the VPS on a database 11. The VPS registers with the acquirer, using the merchant ID and one or more “new” Terminal IDs which identify that it is the VPS performing the communication (not one of the merchants own terminals).

In a typical transaction, the cardholder “browses” the merchants web site, filling a shopping cart with products or selecting to pay for a service, etc. The merchant site will provide the cardholder with details of the goods and services and the total payment required, and obtain from the cardholder delivery details, for example. The merchant does not obtain payment card details from the cardholder. It will be appreciated that this communication takes place over a network, which may be the Internet, using appropriate communication protocols such as TCP/IP and HTTP as well known in the art.

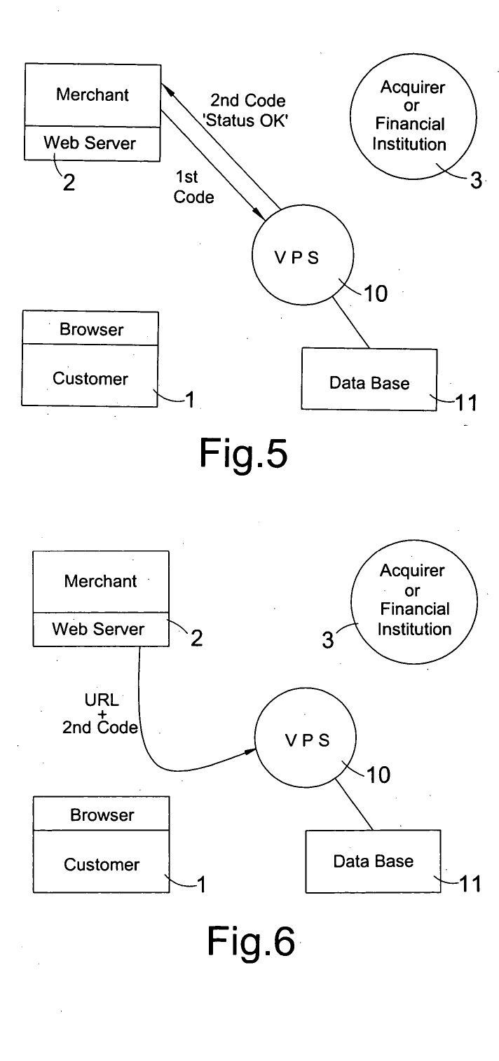

Once the cardholder has confirmed by transmitting an appropriate message or response to the merchant's web server that he wishes to complete the transaction, the merchant's server initiates communication with the VPS (FIG. 5). Typically this will be over a private network or a telephone line (PSTN), but could be via the Internet using HTTPS for example. The merchant's system creates and transmits to the VPS a merchant code for the transaction which is unique on the merchant's system, together with the identifier for the merchant 4 (which is verifiable on the VPS database 11) and the payment to be made, and a description of the goods and services. Provided the message received by the VPS is in the appropriate format, the VPS will return a second unique transaction code to the merchant with a “status OK” message. This second code is unique across the entire VPS system, i.e. it is not used by or for any other merchant, or for any other transaction.

Referring to FIG. 6, the merchant server then sends a re-direct message to the cardholder's computer or communication terminal, to redirect the browser on the terminal to communication with the VPS server, using a URL which includes the second unique identification code. This enables the VPS server to link the “arriving” cardholder with the transaction which has previously been reported to it by the merchant (FIG. 5).

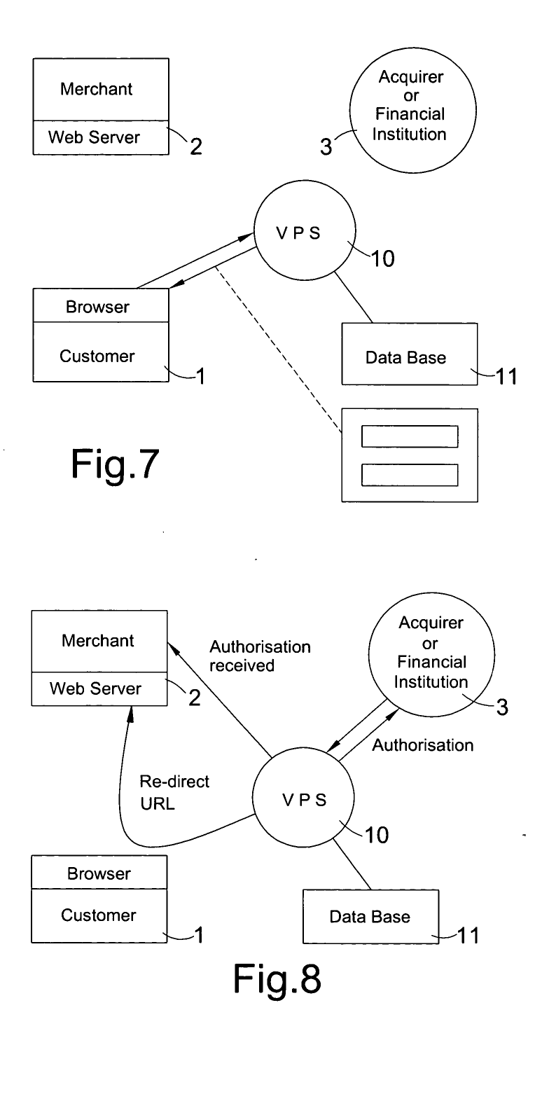

Referring to FIG. 7, when directed to the VPS the cardholder “sees” a VPS main page which will enable the cardholder to enter a user name and pass word to access the payment card pick list for the cardholder. In case the cardholder has not previously been registered with the VPS the main page may also allow the cardholder to register with the VPS, providing credit card details immediately or in a separate communication, or as a third option simply allowing the cardholder to enter card details on the system for a one off transaction. The VPS accesses cardholder information stored on the VPS database for previously registered cardholders.

After the cardholder has selected the appropriate payment card, the VPS then contacts the merchant's designated acquirer over the banking network in order to obtain the appropriate authorisation for the transaction (FIG. 8). The VPS will provide the acquirer with information required by the card payment system, e.g. as specified by APACS, such as the merchant ID, an appropriate terminal ID (TID), the card number, and the amount for the transaction. Under the APACS system this will also include a sequential message number generated at the terminal and may also include a time stamp (YYMMDDhhmm). It will be appreciated that the VPS system will emulate the functionality of multiple terminals on a single computer system, rather than employ a bank of discrete terminals. As indicated above, the TID is one which was previously established by the VPS with the acquirer for use with that merchant ID. It follows that the role of the VPS is or should be known of and approved by the acquirer.

If the required authorisation for the transaction is not received from the acquirer, then the cardholder is advised by the VPS that the request cannot be authorised and may be given the opportunity to select a different card. If the authorisation is received, then the VPS will transmit a “status OK” message to the merchant alongside the transaction code, (or conversely a not authorised message). The merchant then replies to the VPS to confirm that it wishes to complete the transaction, and sends the VPS a re-direct URL, which is transmitted by the VPS to the cardholder's web browser in order to re-direct the customer's browser to access the appropriate page on the merchant's web server. This page may simply be a “thank you, transaction complete” message for example.

The VPS has thus captured on its own database all the details required for a card transaction-such as the merchant ID, terminal ID, the card number, transaction amount and authorisation code.

Overnight, the VPS batches the transactions for all merchants and transmits them to the appropriate acquirers as batch files for the payments to be processed through the banking system, the merchant's account being credited with the appropriate amount, and the cardholder's payment card account being debited. Thus, the system enables a transaction to take place between the cardholder and the merchant without any of the cardholder's payment card details being transmitted to or via the merchant.

As indicated above, when the initial authorisation is requested by the VPS from the acquirer, a shadow is placed on the payment card account by the card issuer, to ensure that subsequent authorised transactions do not, inadvertently, result in the account exceeding the credit limit.

There is still, however, a need for a system which allows deferred payment by a cardholder, for example until goods are received or an instalment is due, without increasing the risk for the merchant that a chargeback will occur because an authorisation or shadow has expired.

In accordance with the present invention, we provide a system for monitoring the authorisation on a payment card account, and for automatically renewing the authorisation on the account under the control of a processor. In the payment system described in relation to FIGS. 4 to 8, this system can be operated by the VPS. However, it will be apparent to those in the art that the system could be operated by another party, including by the merchant, by providing an appropriate interface or gateway between the merchant and the acquirer in order to repeat authorisation requests, as will be described below.

The period for which an authorisation is to be kept open can be set by the merchant. The merchant will agree the period with the cardholder at the time of setting up the transaction with the cardholder.

Details of the transaction are held on a database. Periodically, the authorisation on the transaction is reversed, and a new authorisation obtained. This is done at regular intervals and a frequency to ensure that the last obtained authorisation has not lapsed before a new one is obtained. To avoid having simultaneous authorisations open for a single transaction, the current authorisation is reversed before a new (re) authorisation is obtained.

When the transaction is first authorised a time stamp is created, and reference may be made to this at each re-authorisation to ensure that the agreed period is not exceeded.

When the re-authorisation process is handled by a third party, such as a VPS, the merchant is notified when the agreed period expires, or if a re-authorisation cannot be obtained.

When the transaction can be completed, the merchant processes the transaction with the acquirer, or notifies the VPS. The VPS stores the transaction for completion. The VPS may seek re-authorisation before storing the transaction for completion in the next batch processing operation.

One aspect of the invention provides card payment authorisation apparatus comprising: a data store for storing details of a payment which has been authorised, a program store storing processor implementable instructions, and a processor coupled to the data store and the program store for implementing the stored instructions, wherein the stored instructions comprise instructions for controlling the processor to output a cancellation request to request reversal of the authorisation of the payment and to output a request for authorisation of the payment.

Another aspect of the invention provides a method of maintaining an authorisation for a merchant to receive a payment from a customer by means of a payment card, the authorisation having been issued by an authorising authority, the method comprising sensing to an authorising authority which issued the authorisation a request for reversal of the authorisation and sending to the authorising authority a request for authorisation of the payment.

Other aspects and preferred features of the invention will be apparent from the following description and the accompanying claims.

The invention will be further described by way of example with reference to the drawings, in which:

FIG. 1 illustrates the operation of a payment card settlement system;

FIG. 2 shows a payment card network.

FIG. 3 shows the processing steps for obtaining authorisation on a payment card transaction;

FIGS. 4 to 8 illustrate a verified payment system (VPS) of the prior art;

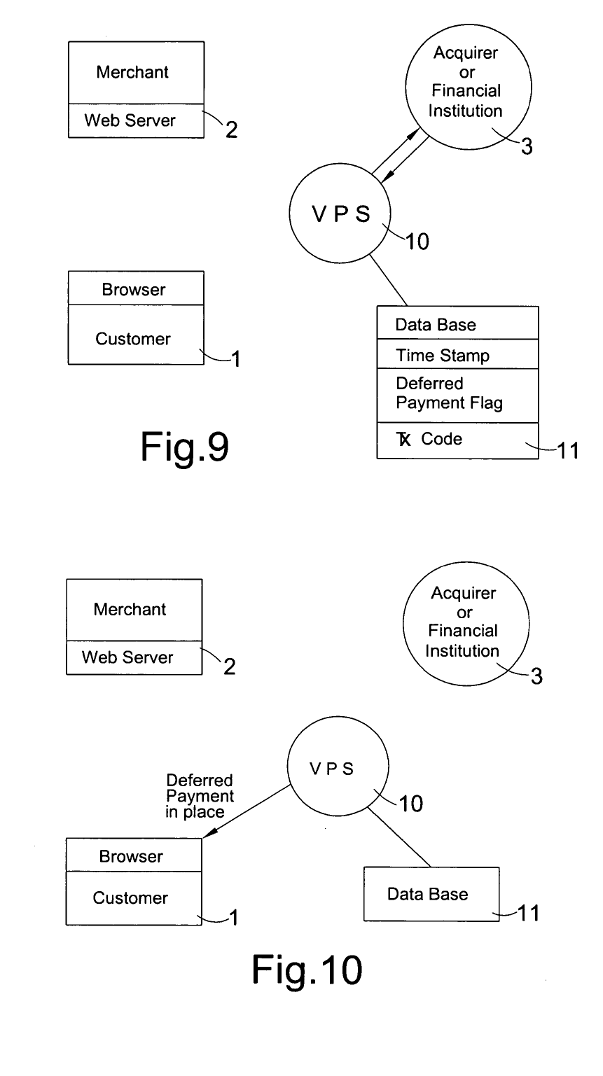

FIGS. 9 to 11 illustrate a VPS utilising a re-authorisation method and apparatus in accordance with the invention;

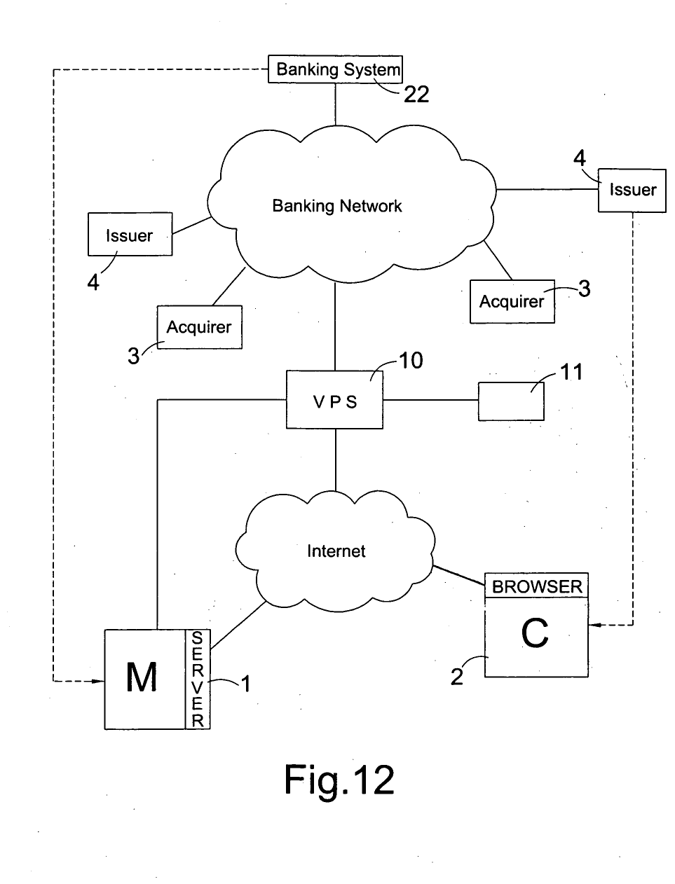

FIG. 12 illustrates a network incorporating the VPS of FIGS. 9 to 11;

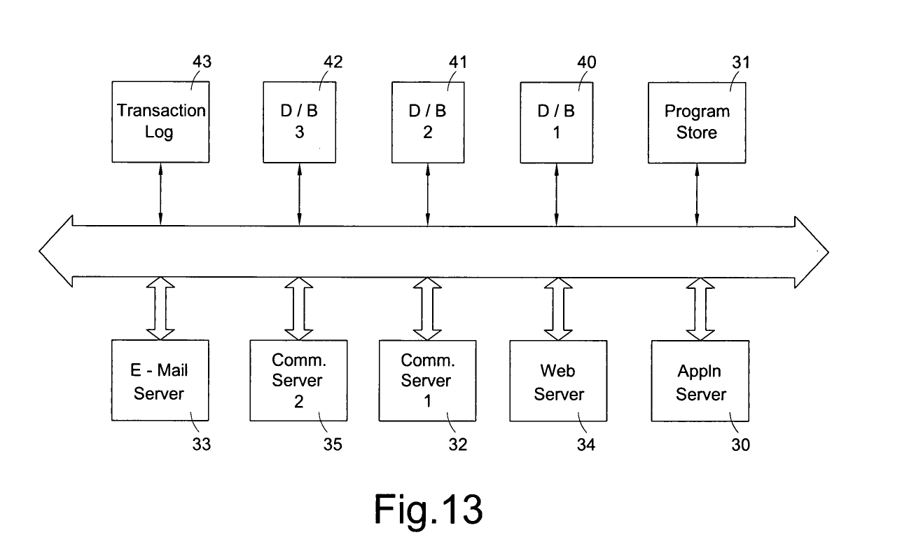

FIG. 13 illustrates a card payment authorisation apparatus in accordance with the invention;

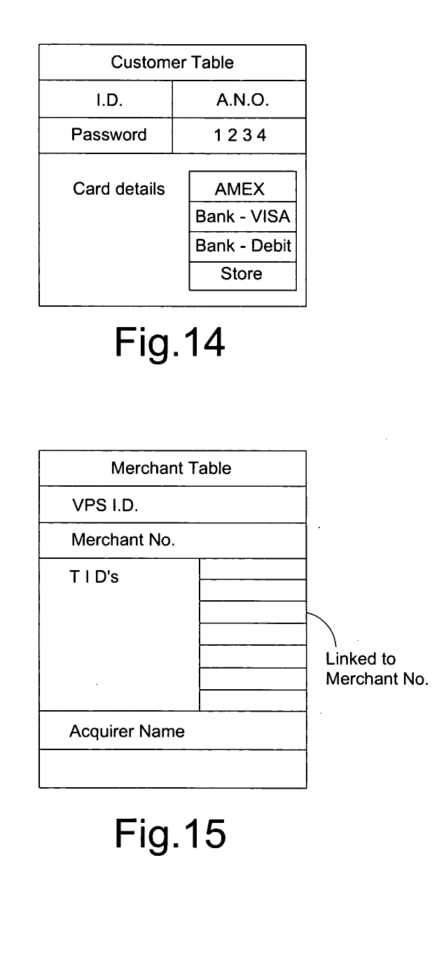

FIGS. 14 to 16 illustrate tables of data utilised by the payment authorisation apparatus of FIG. 13;

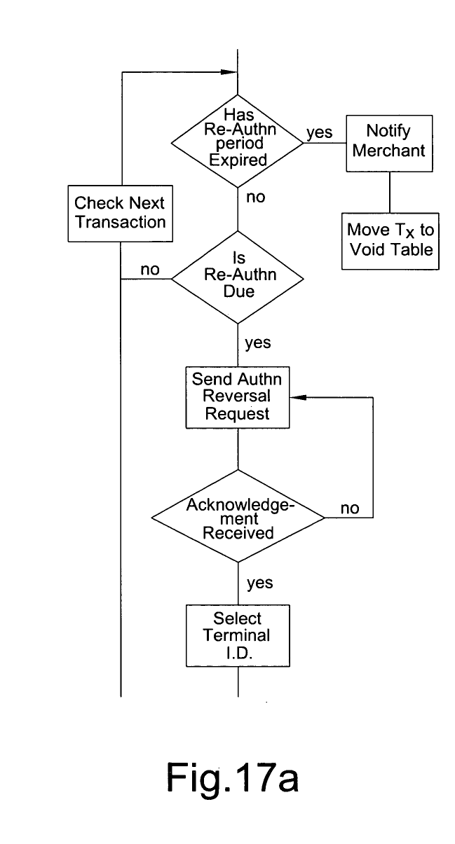

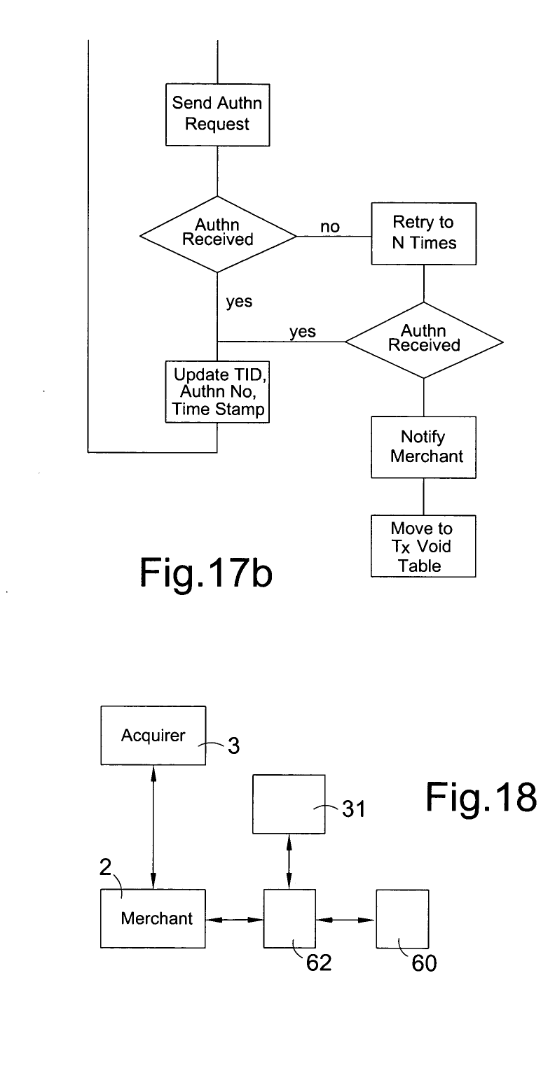

FIG. 17 illustrates a payment authorisation method of the invention; and

FIG. 18 illustrates a second embodiment of the invention.

Referring to FIG. 9, when the VPS 10 seeks authorisation from the acquirer 3 (or other relevant financial institution) the VPS stores the authorisation request and details in a database along with a time stamp. The transaction is also flagged on the database as a “deferred payment” so that it will not be included in the batch files which are transmitted to the acquirer at the end of the day for settlement. As mentioned above, an authorisation lasts for a period of time and places a shadow on a cardholder's account for a period of time, typically from 24 hours to 28 days depending on the card issuer and the card type.

The initial authorisation request sent to an acquirer depends on the payment system or acquirer but typically includes information such as the merchant number and terminal ID, a message number created automatically at the ‘terminal’, a message type (e.g. request for authorisation), card number and transaction amount, and optionally a time of the request. The acquirer returns to the VPS the message number and an authorisation code (or a message indicating authorisation denied, etc.).

As before, the VPS sends a message to the merchant containing the unique transaction reference which has been created by the VPS and confirmation of the authorisation. The merchant can then send the goods etc to the cardholder.

Referring to FIG. 10, the VPS or the merchant advises the cardholder that money for the transaction will not be deducted until the goods are delivered, for example. The merchant or VPS will preferably explain to the cardholder that the authorisation will be maintained on the cardholder's payment card until the transaction is completed after the delivery of the goods. This may indicate that the authorisation will be maintained for a specified period of time. The cardholder is preferably asked to confirm agreement to this.

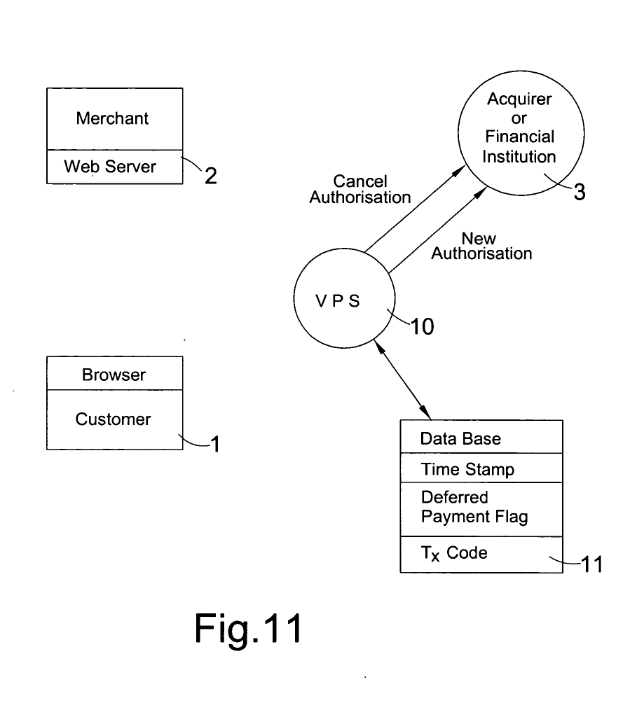

Referring to FIG. 11, the VPS periodically checks the time stamp on each deferred payment logged in the database. If a predetermined period of time has expired from the time stamp (typically 23 hours), then the VPS sends a reversal message to the acquirer which reverses (i.e. cancels) the authorisation, and hence any shadow on the card. The VPS then immediately (within a matter of a few seconds) transmits a subsequent request for authorisation, in effect a re-authorisation, using the details required for the original authorisation but with a message number and a new time stamp. This process re-establishes the authorisation on the card and re-sets the shadow period at the card issuer. Because the transaction has been reversed immediately prior to re-authorisation, the chance of another merchant or other party seeking an authorisation, using up the available card credit, in the intervening period of a few seconds or minutes is very small.

If the re-authorisation is not successful, the VPS will communicate to the merchant, and may periodically re-try to obtain authorisation. Failure to re-authorise may occur because a card has been reported lost in the period since the last authorisation was obtained for example.

It is desirable to reverse an authorisation prior to seeking a re-authorisation, because otherwise there will be a double shadow etc., on the card account, possibly causing the cardholder's credit limit to be exceeded and hence authorisation to be denied. Also, some fraud detection algorithms may prevent the authorisation of the same or similar transactions multiple times in a predetermined period. However, a system in which a payment (i.e. an equivalent payment) is authorised prior to reversing the authorisation on the original (i.e. a previous) payment is within the scope of this invention.

Reversals and re-authorisation are made at allotted time intervals, for example 23 hours from the previous authorisation on a transaction.

Once the cardholder has received the goods or services from the merchant, the merchant or the cardholder (preferably the merchant) will notify the VPS that the goods have been accepted, at which point the VPS will remove the deferred payment flag from the transaction log and pass the transaction through to the acquirer with the usual batch for settlement.

It is preferable for a further re-authorisation to be conducted substantially immediately the goods accepted notification is received by the VPS, to ensure that the authorisation and shadow are in place until the transaction is settled in the next batch settlement. The transaction details can then be transferred by the VPS to a schedule of transactions awaiting batch processing.

In card payment systems, a reversal typically occurs when an authorisation has been obtained and the merchant wishes to cancel it for some reason. Other communication types in the APACS system include a refund if a payment has previously been processed or settled, or a credit if money is to be put onto a debit card.

As indicated above, the data required for executing a reversal may vary with the payment system, acquirer or even the issuer. Typically, it is necessary to provide the acquirer with the merchant number and terminal ID from which the original request for authorisation was made, the card number, and the message number (which was generated by the terminal making the authorisation request). The time of the original authorisation request or issuance may also be given. When the new authorisation is requested, the merchant number, card number and transaction amount will be the same, and possibly the terminal ID, however, a new message number, time and optionally a new terminal ID will be provided and a new authorisation code received from the acquirer. This data can overwrite the data stored in the database. It will be appreciated that a transaction log is retained for the database to provide an audit trail.

Some on-line systems will only allow reversal of an authorisation within a short period of time, perhaps two hours. In that instance, it would be necessary to seek reversal and re-authorisation at periods of less than two hours.

Referring to FIG. 12, in one implementation of the invention, the cardholder 1 is in communication with the merchant 2 and VPS 10 over the Internet using an appropriate protocol such as HTTP, browser software and the like as well known in the art. It will be appreciated that communications between the parties may be encrypted at various stages using encryption routines established by the VPS when the merchant and (optionally) the cardholder registered with the VPS. The VPS 10 in turn communicates with the acquirers 3 (a particular acquirer dealing with a particular merchant) over the banking network. The acquirers 3 also utilise the banking network to communicate with the card issuers 4. An issuer 4 will ultimately communicate with its respective cardholder by post or again by the Internet in order to provide the cardholder with details of transactions on the cardholder's account. The merchant's account is credited with the appropriate payments via the banking system, once the appropriate details have been transferred by the acquirer to request allocation of the funds using the bank clearing system.

As mentioned above, WO99/66436 describes in some detail the operation of the VPS in relation to the cardholder 1 and merchant 2 to provide a secure trusted third party transaction. A commercial implementation of such a system is in use under the trade name PROTX.

The present implementation is concerned with providing an apparatus for renewing the authorisation or shadow on a payment card account and this will be described in more detail with reference to FIGS. 13 to 16. Although applicable to a VPS such as the PROTX system, it is usable generally both with TTP systems and otherwise.

Referring to FIG. 13, the VPS system in one implementation comprises an application server having a programme store 31 which stores programmes or implementable instructions which are operated by the application server 30. Also provided is a communication server for 32 transmitting and receiving data to the banking network 21, an e-mail server which may be used, for example, to communicate with merchant's and customers, a web server 34 for communication with the customer via the customer's web browser and a second communication server 35 to communicate with merchants over the Internet, PSTN or via a private network for example.

A database 40 stores information relating to individual cardholders or customers, such as shown in the Table of FIG. 14. The database 41 stores information related to merchants, such as shown in the Table of FIG. 15.

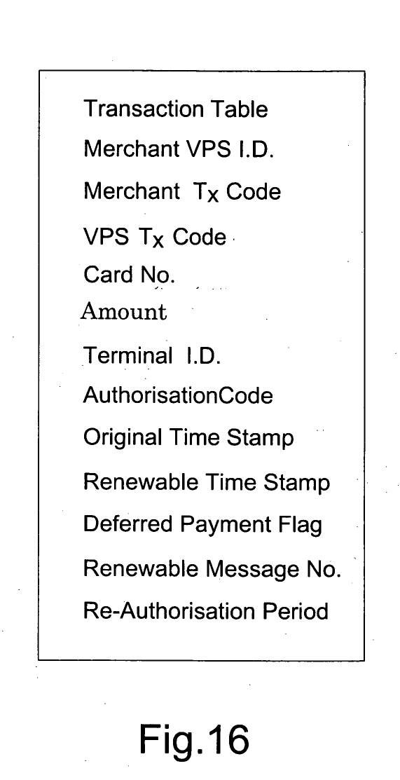

Database 42 stores transaction data for a transaction between a merchant and customer, including the authorisation code etc obtained from the acquirer 3, as set out in the Table of FIG. 16.

The database 43 carries a transaction log for audit purposes.

Referring to FIG. 14, as indicated previously, the VPS 10 stores in database 40 customer data including a user name, password and payment card details such as billing address, account number, issue number, expiry date etc, such as may reasonably be required by an acquirer for verification purposes.

Referring to FIG. 15, the VPS 10 stores in database 41 merchant information such as the acquirer which the merchant uses for settling payment card transactions and terminal ID numbers which have been established by the VPS 10 for use with the acquirer when using the merchant ID number. A merchant may use more than one acquirer, for example using a first for transactions in the local currency and a second for transactions in a foreign currency. The system may allow for identification of the currency of the transaction, and automatically select the appropriate acquirer for that currency.

As seen in FIG. 16, database 42 carries transaction details including the merchants transaction code, and the unique transaction code established by the VPS (the second code) for the transaction between the merchant and the cardholder and the transaction amount. The time stamp, the authorisation code, and the message number generated when requesting authorisation, are obtained during the authorisation process. Each transaction code in database 42 also is associated with a flag indicating whether the authorisation is to be renewed, and the period of time (the re-authorisation period) for which the authorisation is to be kept open on the cardholder's account. The period of time stems from the time stamp (i.e. the time) for the original authorisation process. In the present embodiment, this initial authorisation is obtained by the VPS, which will record the time on the database. In other implementations this may be supplied by the merchant or other party who obtains the initial authorisation.

The application server communicates with the acquirer 3 over the banking network via communications server 32 in order to obtain an authorisation for a new transaction. The application server provides the acquirer with the merchant number and TID, card number, a message number, the transaction amount, and a time stamp. The message to the acquirer can include other fields, including descriptive data.

As mentioned previously, the acquirer 3 then communicates with the issuer 4 to obtain the appropriate authorisation. That communication is private between the acquirer and issuer. The card issuer confirms the authorisation and places a shadow for the authorised amount on the cardholder's card.

To confirm that authorisation has been given, the acquirer 3 transmits to the VPS 10 data such as the merchant number and terminal ID, the message number, the authorised amount together with the authorisation code. These are stored in database 42 alongside the VPS transaction code (FIG. 16).

In accordance with program instructions stored on program store 31, the application server 30 will periodically scan database 42 to locate entries (settled transactions) for which deferred payment is not required or no longer required and create batch files for each acquirer, transmitting to the acquirer the appropriate information which will enable the acquirer to subsequently implement payment to the relevant merchants over the banking system. It will be appreciated that these transactions may be stored in a separate database or part of the database. A flag may be provided to indicate a settled transaction.

Referring to FIG. 17, in accordance with the stored instructions, at periodic intervals, typically twice per hour, the application server 30 will scan on database 42 those transactions for which a requirement for deferred payment, and hence for renewed authorisation, has been flagged. Server 30 firstly determines whether the allowed re-authorisation period (e.g. 28 or 60 days) has expired by reference to the original time stamp, and voids those transactions for which the period is exceeded, notifying the merchant.

Server 30 then determines those transactions for which the authorisation (i.e. the time stamp) is 23 hours old by reference to the renewable time stamp (if present) or the original time stamp. For each such transaction, the application server transmits to the relevant acquirer for that merchant transaction, a request for reversal of the authorisation using the appropriate information detailed above. The acquirer will transmit this request to the issuer who will remove the authorisation and remove any shadow which has been placed on the payment card account. The issuer then communicates confirmation of the process back to the acquirer who in turn communicates to the VPS 10.

There may be some time shift between the acquirer acknowledging a request for reversal, to the VPS 10, and the acquirer actually updating the card issuer. In that circumstance, it is possible that the VPS 10 will seek re-authorisation before the reversal has occurred at the card issuer. This might lead to an authorisation being denied (because the credit limit is exceeded) until the shadow is removed. Thus, multiple attempts at authorisation may be made. Immediately the VPS 10 receives the confirmation back from the acquirer that the authorisation has been reversed, the application server selects a (new) terminal ID and transmits a fresh request using the original authorisation amount, the merchant ID, optionally the same or a new TID, a new message number, the card number, etc. to the acquirer.

When a request for authorisation is made the terminal (identified by the TID) is locked until the authorisation request is completed. Thus, for multiple transaction for a merchant it is desirable to use and to cycle through a number of terminal IDs to ensure that sufficient are available to allow reversals to take place at the appropriate time, bearing in mind that a reversal must be made on the terminal ID which obtained the authorisation. Thus, it is desirable to ensure that there is not a build up of transactions requiring reversal in close time proximity on a single terminal ID for a merchant. As far as the acquirer is concerned, a request for authorisation following a reversal is a completely new request for authorisation from the VPS 10 and so a new terminal ID can be used. This data for the new authorisation is then stored against the transaction ID in database 42.

When the communication server 35 receives a communication from the merchant 2, identifying that the transaction, identified by the unique identifier created by the VPS 10 or by the merchant's VPS ID and internal transaction code has been completed, the application server 30 renews the authorisation code for that transaction immediately and then removes the flag-ensuring that the transaction will then be processed for payment immediately in the subsequent batch.

Referring to FIG. 18, the system for renewing authorisations could also be executed by an individual merchant, for example. The merchant point of sale terminal 2 is configured to store in a database 60, under the control of processor 62, transaction data for a transaction on which the authorisation is to be renewed, because the payment process is to be delayed. On initiating the transaction, the merchant obtains an authorisation from the acquirer 3 in the usual way. The relevant information (the card details, transaction amount, message number) are stored by processor 62 on database 60. After a predetermined period of time, such as 23 hours, processor 62 will instruct the merchant point of sale terminal (which thus uses the same merchant ID and terminal ID) to issue a reversal request to the acquirer 3, to reverse the authorisation on the identified transaction. After the reversal is confirmed, the processor 62 instructs the point of sale terminal to issue a fresh request for an authorisation, using, a new date, and the original authorisation amount. In return, fresh authorisation code is received from the acquirer. Processor 62 can be configured to continue this for a predetermined period of time, or almost indefinitely, on behalf of the merchant. However, there is a danger that the merchants request will maintain a shadow on a card for an indefinite period if the transaction is never completed and so it is preferred that the processor 62 be configured to cease renewing the authorisation code after a predetermined period of time unless overridden by the merchant.

The time period between the initial authorisation request and the first cancellation and re-authorisation, and between subsequent cancellation/re-authorisation is set at a predetermined maximum and is preferably set at a default which will suit all card issuers/card types. Preferably the time period is set at less than 24 hours, and preferably between 20 and 23 hours. It will be appreciated that a cycle which is not a multiple of 24 hours may result in a busy period when the card acquirers are busy with “normal transactions”. The server 32 may be configured to renew authorisations at a variable time period (less than the predetermined maximum) to adjust the workflow. Different time periods may be set for different card issuers or card types, which can be identified from the card number.

1. A card payment authorisation apparatus comprising:
a data store for storing details of a payment which has been authorised,
a program store storing processor implementable instructions, and
a processor coupled to the data store and the program store for implementing the stored instructions, wherein
the stored instructions comprise
instructions for controlling the processor to
output a cancellation request to request reversal of the authorisation of the authorised payment; and to
output a request for authorisation of the payment or an equivalent payment.

2. A card payment authorisation apparatus as claimed in claim 1, wherein the stored instructions comprise instructions for outputting the request for authorisation of the payment or equivalent payment subsequent to the request for reversal of the (previous) authorisation.

3. A card payment authorisation apparatus as claimed in claim 2, wherein the data store stores time data indicative of a time an authorisation is requested, and the stored instructions further comprise instructions for controlling the processor to issue a reversal request a first predetermined period of time after the authorisation is requested.

4. A card payment authorisation apparatus as claimed in claim 3, wherein the first predetermined period of time is less than 24 hours.

5. A card payment authorisation apparatus as claimed in claim 1, wherein the data store stores data indicative of a lapse time after which a payment may cease to be an authorised payment, and the stored instructions further comprise instructions for controlling the processor to issue the request for authorisation of the payment before the lapse time.

6. A card payment authorisation apparatus as claimed in claim 1, wherein the stored instructions further comprise instructions for controlling the processor to cycle through the reversal request and the authorisation request for a plurality of times.

7. A card payment authorisation apparatus as claimed in claim 6, wherein the data store stores an initial authorisation time indicative of a time the initial authorisation is obtained for the payment which has been authorised, and the stored instructions include instructions for controlling the processor to calculate an expiry time, based on the initial authorisation time, after which a request for reversal and/or request for authorisation is no longer output.

8. A card payment authorisation apparatus as claimed in claim 6, wherein the data store stores data indicative of a number of cycles, and the stored instructions further comprise instructions for controlling the processor to cycle through the reversal and authorisation requests a number of times up to the number of cycles.

9. A card payment authorisation apparatus as claimed in claim 1, wherein the data store stores an indicator indicating whether the authorisation on the payment is to be maintained,
and the processor implementable instructions include instructions for controlling the processor to issue a reversal request and an authorisation request only if the indicator indicates that the authorisation on the payment is to be maintained.

10. A card payment authorisation apparatus as claimed in claim 9, wherein the instructions include instructions for controlling the processor to receive a payment completion input indicating that a payment is to be completed.

11. A card payment authorisation apparatus as claimed in claim 10, wherein the processor implementable instructions include instructions for controlling the processor to output an authorisation reversal request and a subsequent authorisation request after a payment completion input is received.

12. A card payment authorisation apparatus as claimed in claim 10, wherein the processor implementable instructions include instructions for controlling the processor to output a payment completion request after a payment completion input has been received.

13. A card payment authorisation apparatus as claimed in claim 12, wherein the processor implementable instructions include instructions for cessation of output of reversal requests and authorisation requests for the payment after a payment completion request has been issued.

14. A card payment authorisation apparatus as claimed in claim 1, wherein the details of a payment which has been authorised include one or more of the following:
a merchant ID,
a terminal ID,
a time stamp,
a card number, and
an authorisation code which has been received from an authorising authority.

15. A method of maintaining an authorisation for a merchant to receive a payment from a customer by means of a payment card, the authorisation having been issued by an authorising authority the method comprising
sending to an authorising authority which issued the authorisation a request for reversal of the authorisation, and
sending to the authorising authority a request for authorisation of the payment.

16. A method as claimed in claim 15, wherein the request for authorisation is sent subsequently to the request for reversal.

17. A method as claimed in claim 15, wherein a reversal request is issued a first predetermined period of time after the preceding authorisation was requested.

18. A method as claimed in claim 17, wherein the first predetermined period of time is less than 24 hours.

19. A method as claimed in claim 15, a lapse time is determined and a reversal request is issued before the lapse time.

20. A method as claimed in claim 16, wherein the reversal request and the authorisation request are cycled through a plurality of times.

21. A method as claimed in claim 20, wherein an expiry time is calculated based on the initial authorisation time, and a request for reversal and/or request for authorisation is no longer issued after the expiry time.

22. A method as claimed in claim 20, wherein an expiry time is provided, based on the initial authorisation time and dependent on a parameter such as the merchant terms of business, after which expiry time a request for reversal and/or a request for authorisation is no longer issued.

23. A method as claimed in claim 20, wherein the reversal and authorisation requests are cycled through a number of times up to a predetermined number of cycles.

24. A method as claimed in claim 16, wherein the data store stores an indicator indicating whether the authorisation on the payment is to be maintained and a reversal request and an authorisation request are issued only if the indicator indicates that the authorisation on the payment is to be maintained.

25. A method in claim 24, wherein when instructions are received to complete a payment, an authorisation reversal request and an authorisation request are made.

26. A method as claimed in claim 25, wherein a final authorisation reversal request and a final authorisation request are made a second predetermined period of time after the instructions to complete payment are received.

27. A method as claimed in claim 26, wherein a status flag is set to indicate no further authorisation reversal request or authorisation requests are to be made after the final requests.

28. A method as claimed in claim 25, wherein a payment completion request is made after a payment completion instruction has been received.

29. A method as claimed in claim 15, wherein the details of a payment which has been authorised include one or more of the following:
a merchant ID,
a terminal ID,
a time stamp,
an authorisation code which has been received from an authorising authority.
